(19) United States
(12) Patent Application Publication
(10) Pub. No.: US 2016/0160364 A1
(43) Pub. Date: Jun. 9, 2016

(54) PHOTOCATALYTIC METAMATERIAL BASED ON PLASMONIC NEAR PERFECT OPTICAL ABSORBERS

(71) Applicant: Pacific Integrated Energy, Inc., San Diego, CA (US)

(72) Inventors: Bala Krishna Juluri, San Diego, CA (US); Shawn Meade, San Diego, CA (US); Phillip J. Layton, San Diego, CA (US)

(21) Appl. No.: 14/875,896

(22) Filed: Oct. 6, 2015

Related U.S. Application Data
(63) Continuation of application No. PCT/US2014/033877, filed on Apr. 11, 2014.
(60) Provisional application No. 61/811,079, filed on Apr. 11, 2013.

(51) Int. Cl. C25B 11/04; C25B 1/00; B01J 35/00; B01J 23/52; B01J 23/89

(52) U.S. Cl. CPC C25B 11/0405; B01J 23/52; B01J 23/8926; B01J 35/004; B01J 35/0033; C25B 1/003

(57) ABSTRACT

The present disclosure provides a photocatalyst that can utilize plasmon resonance based, near-perfect optical absorption for performing and enhancing photocatalytic reactions. The photocatalyst comprises a substrate and a reflective layer adjacent to the substrate. The reflective layer is configured to reflect light. The photocatalyst further comprises a spacer layer adjacent to the reflective layer. The spacer layer is formed of a semiconductor material or insulator and is at least partially transparent to light. A nanocomposite layer adjacent to the spacer layer is formed of a particles embedded in a matrix. The matrix can comprise a semiconductor, insulator or in some cases metallic pores. The particles can be metallic. Upon exposure to light, the particles can absorb far field electromagnetic radiation and excite plasmon resonances that interact with the reflective layer to form electromagnetic resonances.

### CROSS-REFERENCE

This application claims priority to U.S. Provisional Patent Application Ser. No. 61/811,079, filed Apr. 11, 2013, which is entirely incorporated herein by reference.

### BACKGROUND

Reducing the amount of energy required for the production of chemical fuels, such as standard hydrocarbon-based fuels and hydrogen fuel, may have great economic and environmental benefits. Using sequestered CO₂ as a feedstock for producing hydrocarbon fuels, or chemically reducing volatile gases such as methane to less volatile forms for easier storage and transport, may also be beneficial. Wholly using or even partially using sunlight instead of fossil fuels to drive these reactions may have enormous economic and environmental benefits.

Photocatalysis is the acceleration of a photoreaction in the presence of a catalyst. In catalyzed photolysis, light is absorbed by an adsorbed substrate. In photogenerated catalysis, the photocatalytic activity (PCA) depends on the ability of the catalyst to create electron-hole pairs, which generate free radicals (e.g., hydroxyl radicals: .OH) able to undergo secondary reactions.

A photocatalyst is a species that can use light to initiate or speed up a chemical reaction. See N. Serpone and E. Pelizzetti, Photocatalysis: Fundamentals and Applications, 10th ed. New York: John Wiley and Sons, 1989. Semiconductors are the most common photocatalysts, due to an advantageous mix of optical and electronic properties. Specifically, the ability of semiconductors to absorb light and generate a current that can be exchanged with other chemical species at the surface make semiconductors ideal for heterogeneous photocatalytic applications. For example, water splitting, or the formation of molecular hydrogen (H₂) fuel from water, was first demonstrated using a semiconductor photocatalyst by Fujishima et al. See A. FUJISHIMA and K. HONDA, “Electrochemical Photolysis of Water at a Semiconductor Electrode,” Nature, vol. 238, no. 5358, pp. 37-38, July 1972. The photoreduction of carbon dioxide to form less volatile, hydrocarbons such as formic acid, methanol, as well as volatile methane, using a solar reactor based on SrTiO₃ semiconductor material was successfully demonstrated by Halmann et al. See M. Halmann, M. Ulman, and B. Aurian-Blajeni, “Photochemical solar collector for the photoassisted reduction of aqueous carbon dioxide,” Solar Energy, vol. 31, no. 4, pp. 429-431, January 1983. Even further, carbon-carbon bond formation was demonstrated through the formation of ethylene glycol from methanol using a ZnO photocatalyst by Yanagida et al. See S. Yanagida, T. Azuma, H. Kawakami, H. Kizumoto, and H. Sakurai, “Photocatalytic carbon-carbon bond formation with concurrent hydrogen evolution on colloidal zinc sulphide,” Journal of the Chemical Society, Chemical Communications, no. 1, p. 21, 1984.

In addition to using semiconductors being used as large area (macroscopically planar) photoelectrodes, semiconductor particles can be used. See D. S. Miller, A. J. Bard, G. McLendon, and J. Ferguson, “Catalytic water reduction at colloidal metal ‘microelectrodes’. 2. Theory and experiment,” Journal of the American Chemical Society, vol. 103, no. 18, pp. 5336-5341, September 1981. Use of powders is beneficial because of the increased reaction kinetics for particles suspended in a liquid versus large planar surfaces in contact with liquid phase.

While semiconductors are effective photocatalysts at high energy/short wavelength incident light, they absorb very little light in the visible spectrum and therefore only utilize a small portion of the solar spectrum. Researchers have begun to address this problem, by placing metal nanoparticles at the surface of the semiconductor or embedded within it. This allows for absorption of visible wavelengths of light, below the bandgap of the semiconductor, and subsequently enhances photocatalysis through various proposed plasmon resonance-based mechanisms. See W. Hou and S. B. Cronin, “A Review of Surface Plasmon Resonance-Enhanced Photocatalysis,” Advanced Functional Materials, p. n/a-n/a, October 2012; and S. C. Warren and E. Thimsen, “Plasmonic solar water splitting,” Energy & Environmental Science, vol. 5, no. 1, p. 5133, 2012.

One mechanism involves the plasmonically active metal nanoparticles acting as reservoirs for the photo-excited electrons in the semiconductor, decreasing the recombination rate of the carriers that participate in the photocatalytic reaction. See S. C. Warren and E. Thimsen, “Plasmonic solar water splitting,” Energy & Environmental Science, vol. 5, no. 1, p. 5133, 2012. Another mechanism involves the enhancement of the localized electric field in the semiconductor by the metal nanoparticles, which increases the number of photoexcited electron-hole pairs near the surface of the semiconductor, beyond the semiconductors natural state, thus enhancing the photocatalytic activity of the semiconductor. See I. Thomann, B. a Pinaud, Z. Chen, B. M. Clemens, T. F. Jaramillo, and M. L. Brongersma, “Plasmon enhanced solar-to-fuel energy conversion.,” Nano letters, vol. 11, no. 8, pp. 3440-6, August 2011; and W. Hou and S. B. Cronin, “A Review of Surface Plasmon Resonance-Enhanced Photocatalysis,” Advanced Functional Materials, p. n/a-n/a, October 2012. Finally, a third proposed mechanism for the enhancement of semiconductor involves the production of hot electrons and holes, created in the metal nanoparticles, due to plasmon excitation and by designing a Schottky contact between the metal nanoparticle and the semiconductor. Photocatalytic reactions drivin by hot carriers, do not require photons with energy above the band gap of the semiconductor and therefore, allow for a much larger portion of the solar spectrum to be utilitzed. See J. Lee, S. Mubeen, X. Ji, G. D. Stucky, and M. Moskovits, “Plasmonic photoanodes for solar water splitting with visible light,” Nano letters, vol. 12, no. 9, pp. 5014-9, September 2012; M. W. Knight, H. Sobhani, P. Nordlander, and N. J. Halas, “Photodetection with active optical antennas,” Science (New York, N.Y.), vol. 332, no. 6030, pp. 702-4, May 2011; Y. Lee, C. Jung, J. Park, H. Seo, and G. Somorjai, “Surface Plasmon-Driven Hot Electron Flow Probed with Metal-Semiconductor Nanodiodes,” Nano Letters, vol. 11, no. 10, pp. 4251-5, October 2011; and M. Syed, G. Hernández-Sosa, D. Moses, J. Lee, and M. Moskovits, “Plasmonic photosensitization of a wide band-gap semiconductor: converting plasmons to charge carriers.,” Nano letters, pp. 0-4, October 2011.

As with unenhanced semiconductor photocatalysts, researchers have demonstrated applications involving hydrogen production (see S. C. Warren and E. Thimsen, “Plasmonic solar water splitting,” Energy & Environmental Science, vol. 5, no. 1, p. 5133, 2012; I. Thomann, B. a Pinaud, Z. Chen, B. M. Clemens, T. F. Jaramillo, and M. L. Brongersma, “Plasmon enhanced solar-to-fuel energy conversion.,” Nano letters, vol. 11, no. 8, pp. 3440-6, August 2011; and W. Hou, Z. Liu, W. Hsuan, P. Pavaskar, and S. B. Cronin, “Plasmon Resonant Enhancement of Photocatalytic Solar Fuel Production,” vol. 41, no. 6, pp. 197-205, 2011), as well as hydrocarbon production (see W. Hou, W. H. Hung, P. Pavaskar, A. Goeppert, M. Aykol, and S. B. Cronin, “Photocatalytic Conversion of CO₂ to Hydrocarbon Fuels via Plasmon-Enhanced Absorption and Metallic Interband Transitions,” ACS Catalysis, vol. 1, no. 8, pp. 929-936, August 2011).

The final concept, central to the invention, is the near perfect absorber, which refers to a multilayer metamaterial that exhibit very strong optical absorption spectra. Near perfect absorber metamaterials normally consist of three main layers: a nanostructured top layer separated by a metal base mirror by an optically transparent spacer layer. Several embodiments of this concept exist in the literature. These include devices with patterned nanostructured top layers that can be engineered to absorb, select narrow bandwidth regions (see J. Hao, J. Wang, X. Liu, W. J. Padilla, L. Zhou, and M. Qiu, “High performance optical absorber based on a plasmonic metamaterial,” Applied Physics Letters, vol. 96, no. 25, p. 251104, 2010) and devices with nanocomposite top layers composed of nanoparticles embedded in a transparent semimetal oxide, the same as the spacer layer, that are designed to be broadband absorbers (see M. K. Hedayati, M. Javaherirahim, B. Mozooni, R. Abdelaziz, A. Tavassolizadeh, V. S. Kiran Chakravadhanula, V. Zaporojtchenko, T. Strunkus, F. Faupel, and M. Elbahri, “Design of a Perfect Black Absorber at Visible Frequencies Using Plasmonic Metamaterials,” Advanced Materials, p. n/a-n/a, October 2011).

### SUMMARY

The present disclosure provides photocatalyst material configurations and fabrications and operations thereof.

The present disclosure provides plasmon resonance based, near-perfect optical absorbers for performing and enhancing photocatalytic reactions. This can apply to many photocatalytic reactions, such as waste water treatment, hydrogen fuel production, as well as hydrocarbon fuel production from sequestered CO₂. Being a heterogeneous photocatalyst, devices and systems of the present disclosure can also be considered a platform for enhancing the activity of various, existing photocatalytic semiconductor materials. The general aspects of this disclosure include a near-perfect, optical absorber multilayer structure comprising a top layer of metal nanostructures in near-field proximity to a bottom layer of continuous metal (base mirror plane). The nanostructured metal top layer and base mirror plane can be separated by a transparent, or semi-transparent, spacer layer. The metal nanostructures in the top layer can be either embedded in or on top of a semiconductor photocatalyst material. In this configuration, incident electromagnetic radiation (light) can be absorbed very strongly due to electrical (plasmon) and electromagnetic resonances formed between the bottom mirror plane and the top layer of metal nanostructures, resulting in absorption spectra nearly, closely or substantially matching the solar emission spectra. Additionally, the semiconductor photocatalyst present in the metamaterial can be catalytically enhanced by the visible wavelength plasmon resonance of the metal nanostructures, which can in turn be enhanced by the perfect absorber structure. In some cases, hot carriers produced by low energy photons (energy below the bandgap of semiconductor) can be created in the perfect absorber structure that can be used to drive photocatalytic reactions. Such a configuration can enable existing photocatalysts, such as metal oxide semiconductors, which normally only work when exposed to high energy ultraviolet (UV) light, to work more efficiently by utilizing a much larger portions of the solar spectrum.

An aspect of the present disclosure provides a photocatalyst, comprising a substrate and a reflective layer adjacent to the substrate, wherein the reflective layer is configured to reflect light. The photocatalyst further comprises a spacer layer adjacent to the reflective layer, wherein the spacer layer is at least partially transparent to light. A nanocomposite layer adjacent to the spacer layer can be formed of a matrix and particles. Upon exposure to light, the particles absorb far field electromagnetic radiation and excite plasmon resonances that interact with the reflective layer to form electromagnetic resonances. Upon exposure to light, the Reflector layer and the nanocomposite layer can create a resonant region.

Another aspect of the present disclosure provides a photoelectrochemical system, comprising a first electrode, comprising a nanocompositc layer adjacent to a spacer layer, wherein the spacer layer is adjacent to a reflective layer, wherein the nanocomposite layer is formed of a matrix and particles that, upon exposure to light, absorb far field electromagnetic radiation and excite plasmon resonances that interact with the reflective layer to form electromagnetic resonances. The photoelectrochemical system further comprises a second electrode comprising a metallic material adjacent to the first electrode. Upon exposure of the first electrode to electromagnetic radiation, the first electrode and/or the second electrode generate one or more reaction products from at least one reactant species. For example, (i) the first electrode generates an oxidized product from a reactant species and (ii) the second electrode generates a reduction product from the reactant species or a different reactant species. As another example, (i) the first electrode generates a reduction product from the reactant species and (ii) the second electrode generates an oxidized product from the reactant species or a different reactant species.

Another aspect of the present disclosure provides a method for catalyzing a reaction, comprising (a) providing a photoelectrochemical system, comprising a first electrode and a second electrode. The first electrode comprises a nanocomposite layer adjacent to a spacer layer, wherein the spacer layer is adjacent to a reflective layer, wherein the nanocomposite layer comprises a matrix and particles that, upon exposure to light, absorb far field electromagnetic radiation and excite plasmon resonances that interact with the reflective layer to form magnetic resonances. The second electrode comprises a metallic material coupled to the first electrode. A reactant species is in contact with the first electrode and the second electrode. Next, the first electrode is exposed to electromagnetic radiation. Next, one or more reaction products can be generated from at least one reactant species at the first electrode and/or the second electrode. For example, the reactant species can be oxidized at the first electrode and the reactant species (or a different reactant species) can be reduced at the second electrode. As another example, the reactant species can be reduced at the first electrode and the reactant species (or a different reactant species) can be oxidized at the second electrode.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 shows a plasmonic enhanced near-perfect absorbing, photocatalytic metamaterial 100

FIG. 2 shows an example spectrum of a near perfect absorber (Absorbance versus Wavelength (nanometers)). Solar absorption is at about 0.93;

FIG. 3 shows a nanocomposite, plasmonic enhanced, near-perfect absorbing, photocatalytic metamaterial integrated within an photoelectrochemical cell with an optional counter electrode;

FIG. 4 shows a nanopatterned, plasmonic enhanced near-perfect absorbing, photocatalytic metamaterial with nanopatterned metal top layer;

FIG. 5 shows a photocatalytic absorber that is a particle or localized object; and

FIG. 6 shows an example photocatalytic metamaterial.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “nanocomposite,” as used herein, generally refers to a multiphase solid material with a phase that has one, two or three dimensions of less than 500 nanometers (nm), 400 nm, 300 nm, 200 nm, or 100 nm, or structures having nano-scale repeat distances between the different phases that make up the material.

The term “reaction space,” as used herein, generally refers to a reactor, reaction chamber, vacuum deposition chamber, vacuum deposition reactor, or an arbitrarily defined volume in which conditions can be adjusted to effect thin film growth over a substrate by various vacuum deposition methods, such as, e.g., chemical vapor deposition (CVD), atomic layer deposition (ALD), physical vapor deposition (PVD), sputtering and evaporation, including plasma-enhanced variations of the aforementioned methods. A reaction space can include surfaces subject to all reaction gas pulses from which vapor phases chemicals (or gases) or particles can flow to the substrate, by entrained flow or diffusion, during normal operation. A reaction space can be, for example, a plasma-enhanced CVD (PECVD) reaction chamber in a roll-to-roll system of embodiments of the invention. As another example, the reaction space can be a vacuum deposition chamber configured for forming a transparent conductor thin film over a substrate, such as an ITO thin film (or layer).

### Photocatalytic Metamaterials

An aspect of the present disclosure provides a photocatalytic structure embedded in a near perfect light absorber.

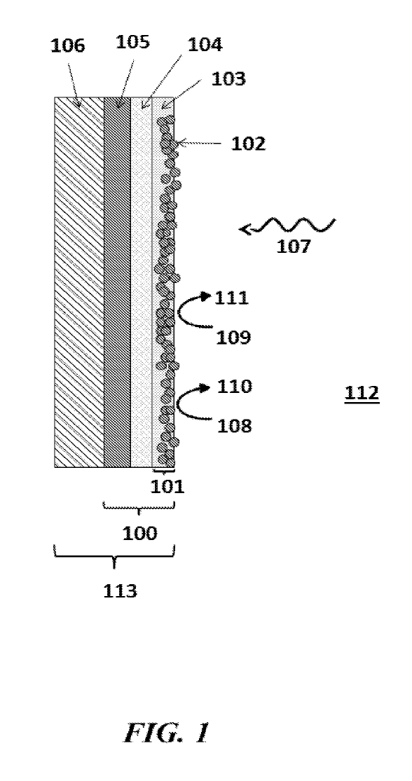

With reference to FIG.1, a strongly optical-absorbing multilayer structure, termed a “near-perfect absorber” 100, can comprise a nanocomposite top layer 101 containing particles 102 embedded in a matrix of photocatalytic material 103 (or photocatalytic matrix). The embedded particles 102 of the nanocomposite top layer 101 can comprise, without limitation, one or more of Au, Ag, Al, Cu, Pt, Pd, Ni, Ti, Ru, Rh, W, indium tin oxide, carbon, and graphene. The particles 102 can include oxides of Au, Ag, Al, Cu, Pt, Pd, Ni, Ti, Ru, Rh, W, indium tin oxide, carbon, and graphene, or combinations thereof. The particles 102 can have particle sizes (e.g., diameters) from about 0.5 nanometers (nm) to 500 nm, or 2 nm to 100 nm, or 5 nm to 30 nm. The particles 102 can be distributed in the matrix 103. The particles 102 can absorb far field electromagnetic radiation (e.g., sunlight or other light sources) and excite plasmon resonances that interact with a base mirror plane 105 to form electromagnetic resonances, which can allow for the enhanced absorption of light in the near-perfect absorber 100. The interaction between the particles 102 and the base mirror plane 105 can occur at a multitude of frequencies, in turn allowing for broadband optical absorption spectra that can match the solar spectrum.

In addition to plasmonic activity, the particles 102 material can be chosen for photocatalytic activity. As an example, the particles 102 can be gold (Au), which can exhibit photocatalytic activity, by itself, upon illumination with ultraviolet light through interband transitions. The particles 102 can include other materials that exhibit photocatalytic activity.

The photocatalytic matrix 103 can be formed of an insulating or semiconductor material. Examples of semiconductor materials include Group IV (e.g., silicon or germanium) and II-VI materials (e.g., gallium arsenide). Examples of materials that can be used in the matrix 103 include TiO₂, Fe₂O₃, SnO₂, and ZnO. Adding a hole transfer material (e.g., such as CuAlO₂) along with other electron transfer semiconductor material can enhance the reaction rates. Additionally, Si, carbon (e.g., diamond), graphene, Ge, SiC, GaN, and other Group III-V and/or II-VI compound semiconductors, as well as AgCl can be used as the photocatalytic matrix 103. The amount of particles 102 embedded in the photocatalytic matrix 103 can be adjusted to change or alter the optical properties of the near perfect absorber 100.

Additionally, the amount of particles 102 exposed above the surface of the photocatalytic matrix 103 can be adjusted by selective etching of the photocatalytic matrix material 103. The property of fill fraction (volume of particles 102 relative to the total volume in the nanocomposite layer 101) and height of particles 102 above the matrix 103 can be adjusted to optimize the absorption spectrum and photocatalytic properties of nanocomposite 113. The middle layer, also termed the spacer layer 104 of the near perfect absorber structure 100, can be made of the same material as the photocatalytic matrix 103, or can be a photocatalytically inert, optically transparent or a semitransparent material. An example of a photocatalytically inert material for the spacer layer 104 can be silicon dioxide. The spacer layer 104 can define the required distance between the particles 102 and the base mirror plane 105 in order to satisfy the physical requirements for a near perfect optical absorber 100 and in some cases allow for the transport of carriers for the photocatalytic reaction. The spacer layer 104 can have a thickness from about 1 nanometer (nm) to 1000 nm, or 1 nm to 500 nm, or 5 nm to 500 nm, or 20 nm to 100 nm, or 10 nm to 30 nm. The layer 101 can have a thickness from about 1 nanometer to 1 μm.

In some cases, the spacer layer 104 can allow for an interaction between plasmon resonance in the metal nanoparticles 102 and the base mirror plane 105. The base mirror plane 105 can be a highly reflective metal surface, such as, but not limited to, Au, Ag, Al, Cu, Pd, Pt, or any combination thereof. A polymer, glass, metal foil or other suitable material can be used as a support substrate 106 adjacent to the base mirror plane 105.

In another configuration the base mirror plane 105 is also a composite formed of a material that is similar or identical to that of layer 101. In this alternative configuration there can also be an additional layer between layer 105 and 106. Such additional layer can be formed of a material that is transparent to the wavelengths of light that are to be collected. For visible light, one such material can be indium tin oxide (ITO) or other similar material. Such additional layer can be electrically conducting.

As an example, one configuration that can be optimized for visible light can have a spacer layer 104 that has a thickness between about 10 nm and 30 nm and comprised of TiO₂ or other suitable semiconductor or insulating material, and a layer 101 with a thickness between about 10 nm and 30 nm and comprises of TiO₂ The layer 101 can be embedded with gold particles 102 that have a fill factor between about 1% and 99%, or 10% and 90%, or 20% and 50%, or 30% and 80%, or 40% and 75%, or 50% and 70%. The gold particles 102 can be smaller than the thickness of layer 101 and can have particle sizes (e.g., diameters) from about 0.5 nm to 500 nm, or 5 nm to 300 nm, or 6 nm to 50 nm, where the fill factor is defined as the percentage of nanoparticles 102 within the matrix material 103. Increasing the thickness of the layer 101 can lead to a red shift in the absorption spectra.

In another configuration more suited for infrared wavelengths, other metal particles 102 can be used that are more suitable for longer wavelength absorption, such as, for example, tungsten. When the absorber 100 is optimized for longer infrared wavelengths, it can use blackbody thermal emitters, such as those produced by engines, solar concentrators or other blackbody emitters with emission peaks or parts of their spectrum in the infrared, such as, for example, emitters with blackbody peaks in the 2 μm to 10 μm range.

For visible light, the nanocomposite 101 can have a thickness from about 5 nm to 100 nm. The spacer layer 104 can have a thickness from about 5 nm to 30 nm. The base mirror 105 can have a minimum thickness of about 1 nm, 2 nm, 3 nm, 4 nm, 5 nm, or 10 nm. The thicknesses can be selected based on the wavelength of light that is to be collected, which in turn can be selected based, for example, on the reaction that is desired to be catalyzed upon exposure of the absorber 100 to light. For example, reactions that have higher activation energies may require more energy to catalyze, in which case a lower wavelength (or higher frequency) of light may need to be collected. The thickness of the nanocomposite layer 101, for example, may be proportional to the activation energy of the reaction that is to be catalyzed upon exposure of the absorber 100 to light.

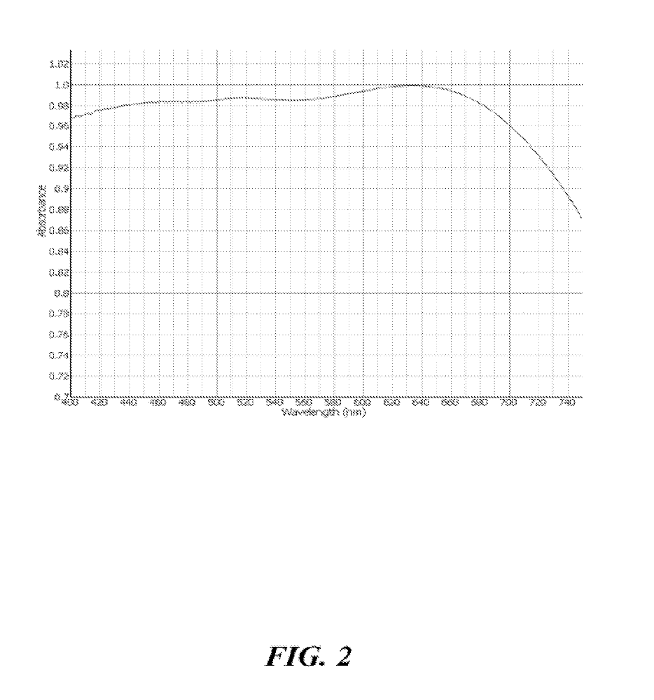

FIG. 2 shows the measured absorption spectrum of visible light for the absorber 100 configured for use with visible light. It can be seen that the absorption exceeds 90% across the visible spectrum. The solar absorbance (i.e., absorption weighted by the solar spectrum) is found to be about 93% (0.93).

With reference to FIG. 1, the absorber 100 can be configured to provide strong enhancement of electric field near an interface between the embedded particles 102 and the photocatalytic matrix 103, which can result in increased number of photoexcited electrons at the surface of the layer 101 and thus provide for photocatalytic reactions. For some photocatalytic reactions, Schottky barriers between embedded particles 102 and the photocatalytic matrix 103 can be designed such that hot electrons in the metal nanoparticles, produced by low energy plasmons, can tunnel over the Schottky barrier into the photocatalytic matrix 103, leaving hot holes in metal nanoparticles. In some cases, when the spacer layer 104 is sufficiently thin, such as at a thickness that is less than about 500 nm, 400 nm, 300 nm, 200 nm, 100 nm, 10 nm, or 5 nm, the plasmon decay in metal nanoparticles 102 produce hot electrons that can directly tunnel into the base mirror 105, leaving hot holes in the embedded metal particles 102. Adding a hole transport material (e.g., such as CuAlO₂) in the matrix can improve hole transport and prevent space charge limitations. Both hot holes and hot electrons created in these processes can be used to drive photocatalytic reactions. Electron-hole pairs are supplied to reactants in the gas or liquid phase 112 adjacent to the surface of the nanocomposite layer 101. In another configuration, matrix material 103 can be porous to allow for a higher surface area to increase the reaction area. The matrix material 103 can have a large range of porosity for example it could range from about 0% to 90%. Higher porosity can allow for more reaction surface area. These pores or surface roughness may also enhance the electromagnetic absorption.

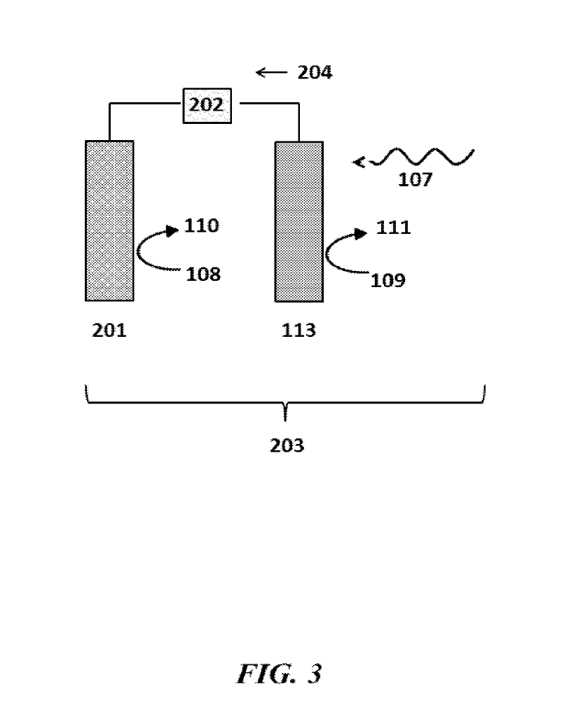

The absorber 100 can be part of a system that is configured to facilitate a photocatalytic reaction. With reference to FIG. 3, during a photocatalytic reaction using the absorber 100, electron-acceptor species 109 and hole-acceptors (electron donor) species 108, form a reduced product 111 and an oxidized product 110 upon illumination of light 107 with the required energy to generate charge (electron-hole pairs) at the surface of the photocatalytic metamaterial 113. In this case no external circuit may be needed because for every electron transferred by the photoelectrode 113 to the species undergoing a reduction 109, a hole is also donated to the species undergoing oxidation 108, thus, keeping charge balance.

It has been demonstrated that gold nanoparticles can plasmonically enhance the photocatalytic activity of titanium dioxide. See W. Hou, W. H. Hung, P. Pavaskar, A. Goeppert, M. Aykol, and S. B. Cronin, “Photocatalytic Conversion of CO₂ to Hydrocarbon Fuels via Plasmon-Enhanced Absorption and Metallic Interband Transitions,” ACS Catalysis, vol. 1, no. 8, pp. 929-936, August 2011, which is entirely incorporated herein by reference. In an example, for methane production, carbon dioxide is the electron-acceptor species 109, forming the reduced product 111, which may be methane, and water is the hole-accepter species 108, forming the oxidized product 110, which may be molecular oxygen (O₂). The absorber 100 in such a case can be a perfect absorber structure, allowing for absorption across the visible spectrum, which can provide for increased production of methane using a broader spectrum of light.

When the reduction 110 and oxidation 111 products need to be produced separately, the absorber 100 can also be incorporated into a photoelectrosynthetic cell setup 203 as the photoelectrode 113, as shown in FIG. 3. This may be necessary in the water splitting application, where a counter electrode 201, made of a metal (e.g., platinum), produces the reduction product of hydrogen 110 in one compartment, while the oxidized product oxygen 111 is formed and collected in a separate compartment containing the photoelectrode 113. Here, the reactant species to be oxidized 109 and the reactant species to be reduced 108 is water. In this system, the photoelectrode 113 is the anode, and electrons 204 flow from the anode 113 to the counter electrode 201, which can be the cathode. Photoelectrochemical cell setups are also useful if an applied electrical potential is needed, since a power supply (or power source) 202 can be incorporated to increase production. In some examples, the power supply is a source of electricity, such as a battery, power grid, wind turbine or photovoltaic system.

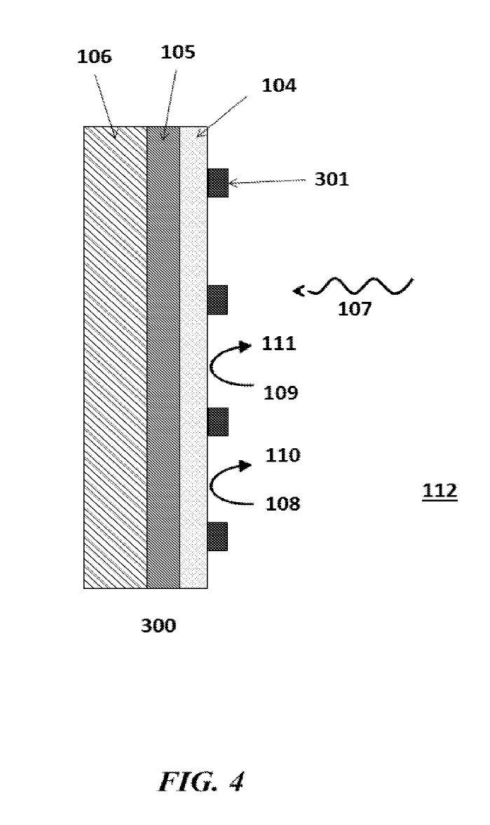

With reference to FIG. 4, in another planar electrode 300 where a wavelength selective, narrow bandwidth, optical absorber is desired, the nanocomposite layer 101 of FIG. 1 can be replaced with a patterned metal layer 301. The patterned layer 301 can include, without limitation, one or more of Au, Ag, Al, Cu, Pt, Pd, Ti, ITO, Ru, Rh, or graphene selected for an optimal field enhancement and light absorption in the desired or otherwise predetermined selective wavelength. In such a case, the photocatalytic matrix 103 may or may not be present. If not present, the spacer layer 104 can include a photocatalytic material as described herein for the photocatalytic matrix 103. Optically, the patterned metal layer 301 behaves the same as the embedded particles 102, which can strongly absorb far field light through a plasmonic resonance interaction with the base mirror plane 105, as described above. With respect to photocatalytic activity, the patterned embodiment 300 behaves the same as the nanocomposite embodiment 113.

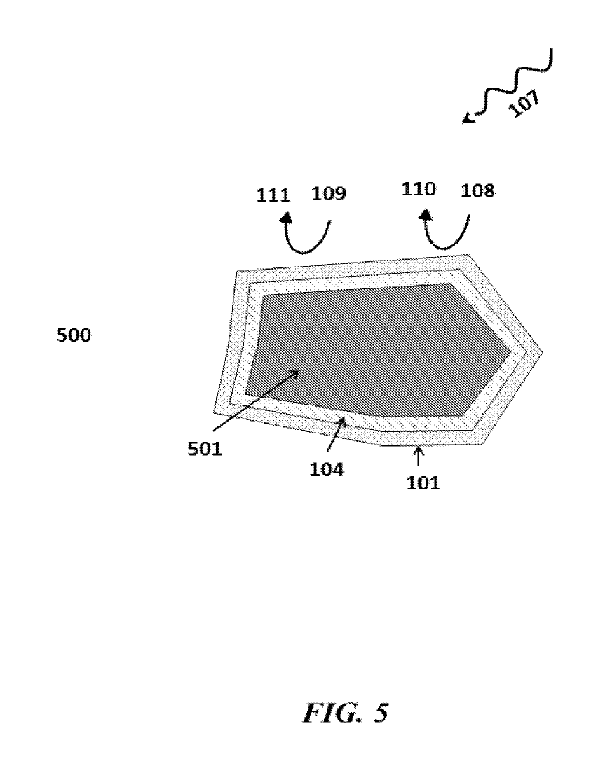

For applications where product separation is not desired and faster solution kinetics is desired, the invention can be in the form of a particle, small localized object, powder, or colloid, photocatalyst. For example, a photocatalyst of the present disclosure can be a colloid that is at least about 100 nm, 200 nm, 300 nm, 400 nm, 500 nm, or 1000 nm in diameter or cross-section. With reference to FIG. 5, in the powder embodiment 500, a metal particle 501 can include, without limitation, Au, Ag, Al, Cu, Pd and Pt, can be coated with the spacer layer 104 described for the nanocompositc planar electrode 101. The spacer layer 104 can be coated with the nanocomposite layer 101 described elsewhere herein. The redox reactants 108 and 109 of the photocatalytic reaction form the products 110 and 111, respectively, as described above. Electron-hole pair generation and participation in the photocatalytic process can be the same as described elsewhere herein, such as in the context of the nanocomposite 101. An advantage of such configuration is that, in some situations, for a given reaction the reaction kinetics may be faster as compared to the same reaction on a large planar surface.

In some examples, the metal particle 501 has a size (e.g., diameter) that is greater than or equal to about 100 nm, 200 nm, 300 nm, 400 nm, or 500 nm; the spacer layer 104 has a thickness that is from about 5 nm to 100 nm or 10 to and 50 nm and comprised of TiO₂; and the nanocomposite layer 101 has a thickness that is from about 5 nm to 100 nm or 10 nm to 40 nm and comprised of a composite of Au and TiO₂. The particle shape can also be used to selectively enhance the absorption of certain wavelengths as was shown in Knight. See M. W. Knight, H. Sobhani, P. Nordlander, and N. J. Halas, “Photodetection with active optical antennas,” Science (New York, N.Y.), vol. 332, no. 6030, pp. 702-4, May 2011, which is entirely incorporated herein by reference. Here absorption may be red shifted with higher aspect ratio particles 500, while shorter and smaller particles are blue shifted (higher frequency). In a particular configuration for near infrared absorption, the particles range in sizes from 100 nm to 160 nm.

### Methods for Forming Photocatalytic Metamaterials

Another aspect of the present disclosure provides methods for forming absorbers. Absorbers can be formed in reaction spaces having controlled environments, such as a chamber that is maintained under vacuum using a vacuum pumping system. A vacuum pumping system can include, for example, a mechanical pump, a turbomolccular (“turbo”) pump, an ion pump a cryogenic pump, or a combination thereof (e.g., turbo pump backed by a mechanical pump). Such chambers can be formed with various sources of chemical constituents that comprise the various layers of the absorber, such as gas sources.

A method for forming an absorber can comprise providing a substrate in a reaction space. The substrate can be a wafer, such as, for example, a glass wafer. An exposed surface of the substrate can be cleaned, such as upon exposure to an oxidizing agent (e.g., H₂O₂ or ozone) or sputtering (e.g., Ar sputtering). This can be followed by annealing, such as annealing to a temperature of at least about 200° C., 300° C., 400° C., or 500° C. The substrate can be heated at such temperature for a time period of at least about 0.1 seconds, 10 seconds, 30 seconds, 1 minute, 10 minutes, 30 minutes, or 1 hour.

Next, a base mirror plane is formed adjacent to the substrate. The base mirror plane can be formed of a semiconductor or insulating material, or a metallic material. The base mirror plane can be formed by various deposition techniques, such as chemical vapor deposition (CVD), atomic layer deposition (ALD), or physical vapor deposition (PVD). In an example, the base mirror plane comprises Al and is formed using PVD.

As an alternative, the base mirror plane can be formed of a highly reflective metal surface, such as, but not limited to, Au, Ag, Al, Cu, Pd, Pt, or any combination thereof. In such a case, the base mirror plane can be formed by PVD, such as PVD of Au.

Next, a spacer layer is formed adjacent to the base mirror plane. In some examples, the spacer layer can be formed of a semiconductor or insulating material. The spacer can be formed by various deposition techniques, such as CVD, ALD or PVD. In an example, the base mirror plane comprises TiO₂ and is formed using ALD, which can include alternately and sequentially contacting the substrate with a source of titanium (e.g., by physical vapor deposition) following by exposing the substrate to an oxidizing agent, such as oxygen (O₂).

During or subsequent to the deposition of the spacer layer, the spacer layer can be annealed, such as to a temperature of at least about 200° C., 300° C., 400° C., 500° C., or 600° C. The spacer layer can be heated at such temperature for a time period of at least about 0.1 seconds, 10 seconds, 30 seconds, 1 minute, 10 minutes, 30 minutes, or 1 hour.

Next, a nanocomposite layer can be formed adjacent to the spacer layer. In some examples, the top layer can be formed of one or more semiconductor or insulating materials forming a matrix that holds metal nanoparticles. The top layer can be formed by various deposition techniques, such as CVD, ALD or PVD. In an example, the top layer comprises TiO₂ and is formed by co-sputtering TiO2 with Au to form Au nanoparticles embedded in TiO₂. The semiconductor matrix can also include additional semiconductors including hole transporting material such as CuAlO₂ to increase the reaction rate.

During the formation of the top nanocomposite layer, metal particles may also be embedded in the top layer by exposing the top layer to a source of a metal, such as a source of gold. In some examples, the metal particles are embedded in the top layer by laser heating of a thin layer of the metal. This will work if the matrix is porous. During or subsequent to the deposition of the top layer, the top layer can be annealed, such as to a temperature of at least about 200° C., 300° C., 400° C., 500° C., or 600° C. The top layer can be heated at such temperature for a time period of at least about 0.1 seconds, 10 seconds, 30 seconds, 1 minute, 10 minutes, 30 minutes, or 1 hour.

As an alternative to metal particles, a patterned layer of a metallic material may be provided adjacent to the spacer layer. The patterned layer can be formed using various lithographic techniques, such as photolithography, for example, by using a mask to define a pattern in a reticle, and subsequently transferring the pattern to a layer of the metallic material to define the pattern.

### EXAMPLE

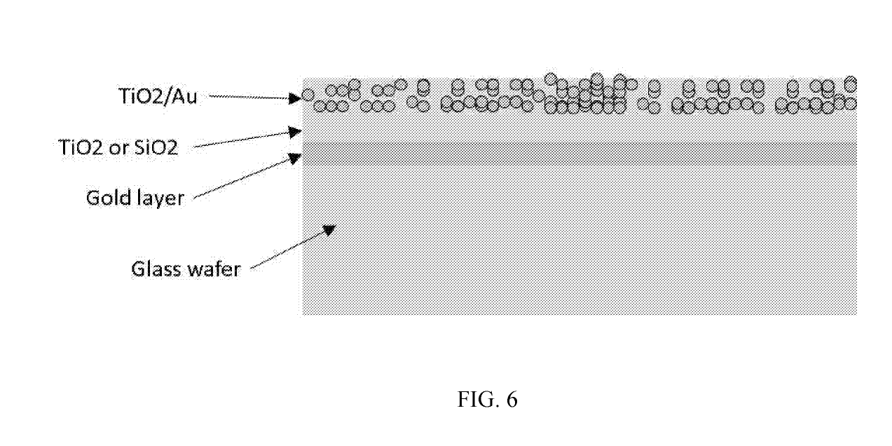

FIG. 6 is an example photocatalytic metamaterial comprised of a nanocomposite layer of gold particles embedded in a TiO₂ (or SiO₂) matrix. This matrix can have more than one semiconductor such as a composite of semiconductors including TiO₂ mixed with CuAlO₂ which can improve the hole transport in the reaction. The nanocomposite layer is disposed adjacent to a spacer layer which is composed of TiO2 or SiO2. The spacer layer is disposed adjacent a gold layer which is disposed adjacent to a glass wafer. Were the glass wafer is used only for support and as such an suitable support material can be used.

The photocatalytic metamaterial of FIG. 6 can be formed by initially cleaning a glass wafer to remove any contaminants on a surface of the wafer. The glass wafer can be cleaned upon exposure to an oxidizing agent, such as H₂O₂ or ozone. Next, a layer of gold can be deposited on the glass wafer. The layer of gold can be deposited by physical vapor deposition (e.g., by sputtering a gold target). Next, a layer of TiO₂ (or SiO₂) can be deposited on the gold layer, by ALD or PVD. Next, gold particles are formed in the TiO₂ (or SiO₂) layer, such as by sputtering gold particles onto the TiO₂ (or SiO₂) layer or using a co-sputtering of the both the TiO2 and the Au.

While preferred embodiments of the present invention have been shown and described herein, it will be obvious to those skilled in the art that such embodiments are provided by way of example only. It is not intended that the iinvention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A photocatalyst, comprising:
a substrate;
a reflective layer adjacent to said substrate, wherein the reflective layer is configured to reflect light;
a spacer layer adjacent to said reflective layer, wherein said spacer layer is at least partially transparent to light; and
a nanocomposite layer adjacent to said spacer layer, wherein said nanocomposite layer is formed of a matrix and particles, and wherein upon exposure to electromagnetic radiation, said particles absorb far field electromagnetic radiation and excite plasmon resonances that interact with said reflective layer to form electromagnetic resonances.

2. The photocatalyst of claim 1, wherein said matrix is formed of a semiconductor or insulator material.

3. The photocatalyst of claim 1, wherein said particles are formed of one or more of Au, Ag, Al, Cu, Pt, Pd, Ti, indium tin oxide, Ru, Rh, W, C and graphene.

4. The photocatalyst of claim 1, wherein said nanocomposite layer is porous.

5. The photocatalyst of claim 1, wherein said matrix is formed of one or more of titanium oxide, silicon oxide,CuAlO_{2,} Fe₂O₃, SnO₂, ZnO, graphene, SiC, GaN and AgCl.

6. (canceled)

7. The photocatalyst of claim 1, wherein said spacer layer comprises a semiconductor or an insulator.

8. The photocatalyst of claim 1, wherein said particles and matrix are formed of porous metal, carbon or graphene.

9. The photocatalyst of claim 1, wherein said spacer layer has a thickness from about 1 nanometers (nm) to 500 nm.

10. The photocatalyst of claim 1, wherein said nanocomposite layer has a thickness from about 1 nanometer to 1 μm.

11. The photocatalyst of claim 1, wherein said photocatalyst is a colloid that is at least about 100 nanometers in diameter.

12. The photocatalyst of claim 1, wherein said nanocomposite layer has a fill factor between 10% and 60%.

13. A photoelectrochemical system, comprising:
a first electrode, comprising a nanocomposite layer adjacent to a spacer layer, wherein said spacer layer is adjacent to a reflective layer, wherein said nanocomposite layer is formed of a matrix and particles that, upon exposure to electromagnetic radiation, absorb far field electromagnetic radiation and excite plasmon resonances that interact with said reflective layer to form electromagnetic resonances; and
a second electrode comprising a metallic material adjacent to said first electrode,
wherein said first electrode and/or second electrode are adapted such that, upon exposure of said first electrode to electromagnetic radiation, said first electrode and/or said second electrode generate one or more reaction products from at least one reactant species.

14-16. (canceled)

17. The photoelectrochemical system of claim 13, wherein said nanocomposite layer is porous.

18-22. (canceled)

23. The photoelectrochemical system of claim 13, wherein upon exposure of said first electrode to electromagnetic radiation, (i) said first electrode generates an oxidized product from said reactant species and (ii) said second electrode generates a reduction product from said reactant species.

24. The photoelectrochemical system of claim 13, wherein upon exposure of said first electrode to electromagnetic radiation, (i) said first electrode generates a reduction product from said reactant species and (ii) said second electrode generates an oxidized product from said reactant species.

25. The photoelectrochemical system of claim 13, wherein said nanocomposite layer is nanopatterned.

26. (canceled)

27. A method for catalyzing a reaction, comprising:
(a) providing a photoelectrochemical system, comprising:
a first electrode comprising a nanocomposite layer adjacent to a spacer layer, wherein said spacer layer is adjacent to a reflective layer, wherein said nanocomposite layer comprises a matrix and particles that, upon exposure to light, absorb far field electromagnetic radiation and excite plasmon resonances that interact with said reflective layer to form magnetic resonances;
a second electrode comprising a metallic material coupled to said first electrode;
a reactant species in contact with said first electrode and said second electrode;
(b) exposing said first electrode to electromagnetic radiation; and
(c) generating one or more reaction products from at least one reactant species at said first electrode and/or said second electrode.

28-33. (canceled)

34. The method of claim 27, wherein said particles and matrix are formed of a metal, or carbon or graphene that is porous

35-36. (canceled)

37. The method of claim 27, wherein said photoelectrochemical system comprises multiple colloids or particles that each contain a nanocomposite layer, a spacer layer and a reflector layer that have thicknesses greater than 100 nanometers.

38-39. (canceled)

40. The method of claim 27, wherein (c) comprises generating one or more reaction products from said at least one reactant species at said first electrode and said second electrode.

41. The method of claim 27, wherein (c) comprises generating an oxidized product from said reactant species at said first electrode and generating a reduction product from said reactant species at said second electrode.

42. The method of claim 27, wherein (c) comprises generating an oxidized product from said reactant species at said second electrode and generating a reduction product from said reactant species at said first electrode.
